(19) United States
(12) Patent Application Publication
(10) Pub. No.: US 2005/0228583 A1
(43) Pub. Date: Oct. 13, 2005

(54) Parked vehicle re-location and advertising/promotion/coupon distribution device

(76) Inventor: Patrick J. Capuano, Bethesda, MD (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/104,426

(22) Filed: Apr. 13, 2005

Related U.S. Application Data
(60) Provisional application No. 60/561,541, filed on Apr. 13, 2004.

(51) Int. Cl. G01C 21/26

(52) U.S. Cl. 701/207; 340/932.2

(57) ABSTRACT

A device or system of devices which a person can use to easily remember the location of a vehicle in a parking garage, parking lot, street or other such area used for parking or storing vehicles. The device or system of devices can also be used by a destination-operator to notify a person of the business at that destination, sales, services, etc. in order to attract a prospective destination-utilizer to that destination. The device or system of devices may provide coupons or other transaction-inducing indicators for use at one or more destinations. The device or system of devices may include a paper scroll which extrudes from the device or system of devices, which paper scroll may describe the location of a vehicle, the best exit path to reach the vehicle from one or more parking-utilizing destinations, and an advertisement and/or coupon and map for one or more parking-utilizing destinations. The device or system of devices may also utilize basic technologies such as paper, paper-rolls, printers and the like to perform its functions. The device or system of devices may utilize any of the following technologies to perform it's functions, including but not limited to electronics, radio-frequency identification tags, radio-wave, laser, micro-wave, infra-red data transfer, or any other technology that may be useful. The device may also be used to keep track of the location of goods which have been placed in an indoor or outdoor storage facility. The device may also be used to help patrons of events such as indoor or outdoor concerts, athletic events, rallies and the like keep track of their seat location and retrieve instructions for returning to the seat after leaving the seat to purchase food, drinks, use the bathrooms, or engage in other such activities. While patrons at these events have tickets with seat numbers, the tickets often do not have maps and it is easy to get lost in a crowded facility where many areas look the same. The device provides information to the immediate user, and also a space for advertising or promotions for businesses.

### RELATED APPLICATION

This application claims the benefit of U.S. Provisional Application Ser. No. 60/561,541 filed Apr. 13, 2004 titled “Parked vehicle re-location and advertising/promotion/coupon distribution device.”

### BACKGROUND OF THE INVENTION

This invention relates to the general field of inventions which attempt to assist parking-space utilizers to locate their vehicles after the person has completed their business for which they needed the parking space. Generally, such destinations include shopping malls, shopping centers, professional, college and other sports stadia and other facilities, grocery stores, or general shopping or business districts, and residential areas where vehicle parking is accommodated.

The prior art is comprised of devices which follow three basic approaches of utilization. In one stream, the vehicle parker may attach to the vehicle a device which will make seeing the vehicle from a distance easier. Example of this stream include flashing lights, sound-emitting devices such as horns or buzzers, flags or lights on extendible arms, and the such. These devices may be activated manually upon exiting the vehicle or automatically when the parker returns to the vicinity of the vehicle. In the former, the vehicle parker turns on a flashing light or raises a flag; in the latter case a vehicle seeker presses a button on a small transmitter and when the signal is received by the device, a light turns on, an alarm sounds, or the flag is raised automatically. Patents in this stream include patents numbered U.S. Pat. Nos. 6,246,314, 6,239,701, and 5,933,081.

The second stream of prior art utilizes an electronic or mechanical hand-held device into which the vehicle parker may manually enter identifying criteria for the parking space as the garage or lot may provide. This data may include a color code, or a space number and floor number. The device may be a simple paper card with manually selectable markings designating parking locations, or more technologically advanced mechanical or electronics product which the user manipulates to record vehicle location. Examples from the prior art of this stream include patents or patent applications numbered U.S. Pat. Nos. 4,881,758, 5,190,319, 6,114,953, 6,400,358, U.S. 2001/0045896 and U.S. 2002/0008614.

The third stream of prior art utilizes the system of global positioning satellites to locate a vehicle. In this stream, vehicles will be equipped with transceivers which emit a signal, and the parker of the vehicle will carry a second transceiver which relays the location of the vehicle and displays directional arrows which would direct the seeker towards the vehicle.

This prior art does not practically serve the needs of the parked vehicle seeker. The major problem with the first stream of devices is that they require that the parked vehicle seeker must already be in the vicinity of the parked vehicle for the device to work. If a parked vehicle seeker is not already within line of sight or hearing of the vehicle, the device will not be able to guide the seeker, which is the purpose. Thus, the devices in this stream will work only if a person already remembers most of the parking location information.

The prior art in the second stream is deficient in that they require that the parking vehicle seeker must carry an additional device with them in order to record the data. Either the parker must carry an additional pen or pencil, key-chain, keypad, or mechanical roller to enter the data, or purchase some other hand-held device to record the data. These extra purchases are cumbersome for the user. Further, in the case of cards which may be “scratched-off,” the cards must be redesigned to accommodate the parking scheme of every garage, and changed to accommodate every change in scheme, and this is economically detrimental for the owner of the garage or lot.

A further deficiency of the second stream is that they do not permit garage and lot owners and operators to change their lot constructions methods to take account of new parking lot technologies. If a new technology arises, the old devices will become obsolete.

The prior art in the third stream is deficient in that it relies on a technology which is unreliable within concrete or underground parking structures. In this stream, the only device which would be powerful enough to utilize GPS technology from within a large concrete structure, and/or underground, would be too large and expensive to be of practical use to the common parker, and so of limited commercial benefit.

A major deficiency of all three streams of prior art is that they put the onus of providing a vehicle locating system on the parker of the vehicle. This is just one more requirement for the vehicle parker, when that person will be thinking about shopping, a business engagement, taking care of a little child, and the like.

Finally, all three streams are deficient in that they do not actively provide a flexible and efficient means for the owner of the garage or lot to increase their revenue base. The current invention solves this deficiency by providing a means for the garage owner to sell advertisements through the system and so turn a revenue neutral facility into a revenue generating facility.

It is true that other patents exist for containers used specifically to distribute coupons in retail grocery stores. One manufacturer of these boxes is a company called Floorgraphics, Inc. In the boxes marketed by this company and others, a stack of coupons is placed inside a little plastic box, and the box is attached to a shelf near the item which is the subject of the coupon. Customers are free to pull a coupon out of the box if they wish to purchase the item. Some of the boxes contain not coupons but note-papers with recipes and/or nutritional information about the product. Some boxes are designed so a coupon can be removed only when a customer pulls one; others are designed so the coupon is automatically extruded from the box by a small internal mechanism. Patents or applications covering these types of items include

| | | |
|---|---|---|
| 5,390,820 | February 1995 | Wright, et al |
| 5,845,259 | December 1998 | West, et al. |
| 6,267,263 | July 2001 | Emoff, et al. |
| 6,367,654 | April 2002 | Simpson |

The above-noted prior art generally refers to devices which permit coupons to be distributed inside a grocery store. The claims on these items specifically do not cover extruded papers which contain maps and automobile-location designations for use within a parking garage. This prior art is rigid and inflexible, requiring a set stack of solely pre-printed papers to be distributed, which cannot be altered without throwing away unused papers and thus incurring wasteful business expenses. Other coupons which are slightly more flexible, so-called check-out coupons, are distributed after a purchaser has completed their purchasing and perhaps even purchased products which compete with those of the coupon. Further, the prior art described above provides for coupons which are individually stacked. This limits the length and width of the individual coupons, and so effectively restricts the design options for the coupons. Further, the fact that these devices are to be placed on store shelves where visible space is of high value, even the size of the box itself exerts an added burden on the business owner.

### BRIEF DESCRIPTION OF THE FIGURES

These and other advantages of the present invention will be more readily understood when taken in conjunction with the accompanying detailed description and the attached drawings in which like numerals represent like elements and in which:

FIG. 1 shows a sample system 1 comprised of bottom-dispensing paper scroll 2, a dispensed paper 2a, a push-to-dispense button 3, key-pads for manually entering parking location data 4, read-out of parking location data 5, electronic data beam or signal emitter 6, antenna for receiving and transmitting printer and location data 7, and cell-phone key code plate 8.

FIG. 2 shows a sample dispersal of a set of systems 1 placed at effective distances from each other around a parking structure 9 and able to communicate with each other and remote devices using antennas 7.

FIG. 3 depicts a sample dispersal of sets of systems 1 in parking structures 9 in various cities across the country and how they can be remotely programmed from a central programming output center 10 based upon the needs and desires of various commercial entities 11.

### DETAILED DESCRIPTION OF THE FIGURES

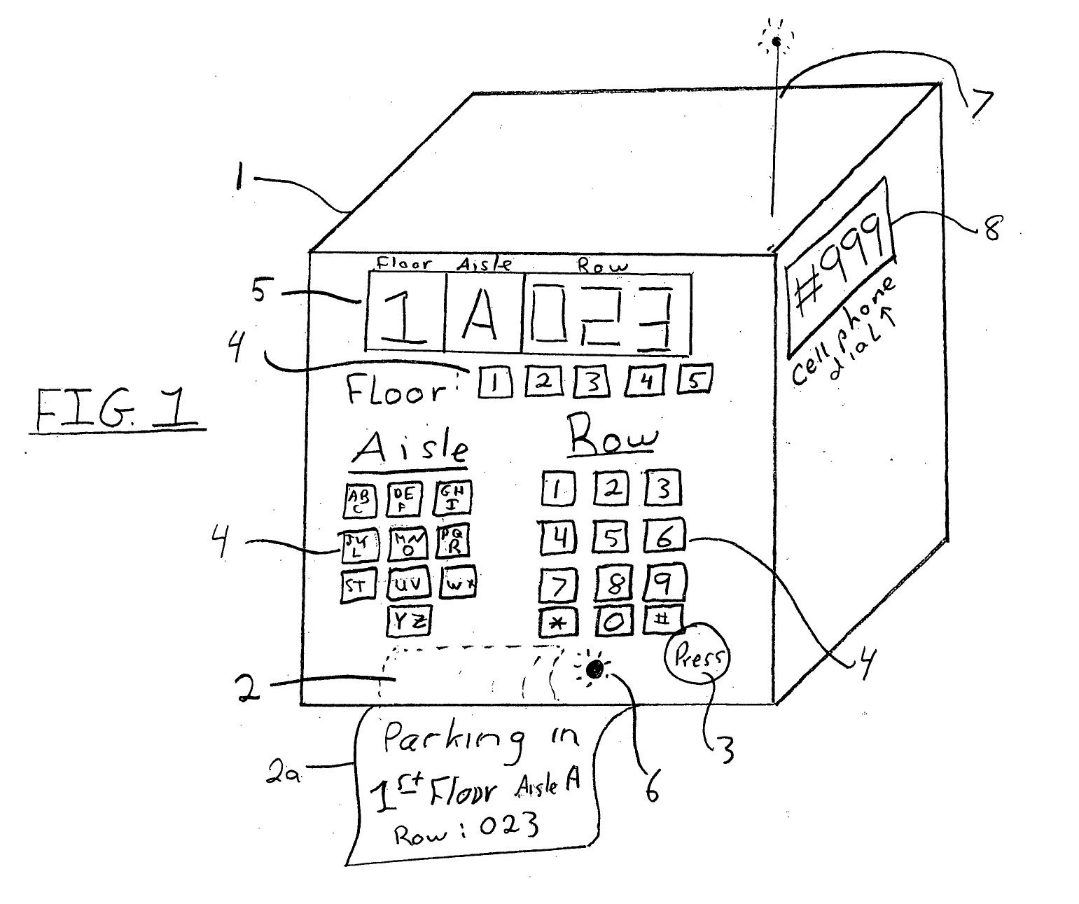

FIG. 1 shows a sample system 1 comprised of bottom-dispensing paper scroll 2, a dispensed paper 2a, a push-to-dispense button 3, key-pads for manually entering parking location data 4, read-out of parking location data 5, electronic data beam or signal emitter 6, antenna for receiving and transmitting printer and location data 7 and cell-phone key code plate 8. A vehicle parker will utilize the system by parking their vehicle in any open parking space in the parking structure 9. The parker will then walk to the nearest system 1, anticipated to be within sight of the vehicle and likely no more than 20-25 feet away. It is anticipated that there will be at least one system located at either end of each row of parking spaces and several in between as needed. The vehicle parker then has several options to receive the parking location notice: The parker may press the release button 3 for a notice applicable to the general area, or they may enter specific data manually using the key pads 4, or they may retrieve the data to their cell-phone or other digital device by entering a code on their phone or digital device publicized on the front of the system (for example, “#999). A vehicle parker may press the release button several times if several copies are needed. Before expelling the paper or sending the data stream, the system attaches an advertisement and/or coupon and a time/date stamp to the paper or electronic parking lot location message. The advertisement and/or coupon has been programmed into the system and is applicable for that location; the time/date stamp and date-sensitive code number will be generated by the system software. The parker then continues with their business, comfortable in the fact that they have a record of where they have parked their car; the whole action will take less than 3 seconds. Once in the retail center, the parker may enter the parked vehicle's location in any system placed around the commercial are and receive directions (on paper or electronically) for the shortest route back to that vehicle's location. The coupon may be exchanged as permitted in the shopping venue. It bears noting that when a vehicle parker retrieves parking location and advertising data through electronic means such as a cell phone, Blackberry device, personal digital assistant or other such tool, the transferred data may include walking maps, instructions, store guides and other information regarding specials then active at that commercial center.

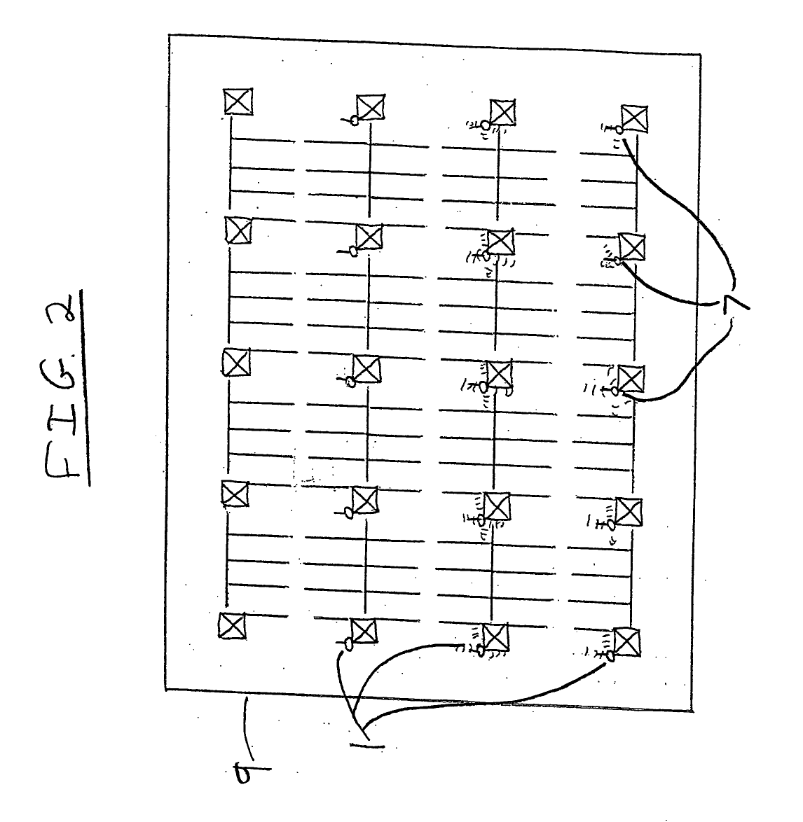

FIG. 2 shows a sample dispersal of a set of systems 1 placed at effective distances from each other around a parking structure 9 and able to communicate with each other and remote devices using antennas 7. In this configuration, the systems are able to triangulate amongst themselves to determine the structure of the parking facility and their relative locations. This provides for tremendous ease of setting up the system in any parking structure of any configuration. A wide dispersal of systems provides vehicle parkers with ample nearby options and locating a vehicle when shopping has been completed will be simple.

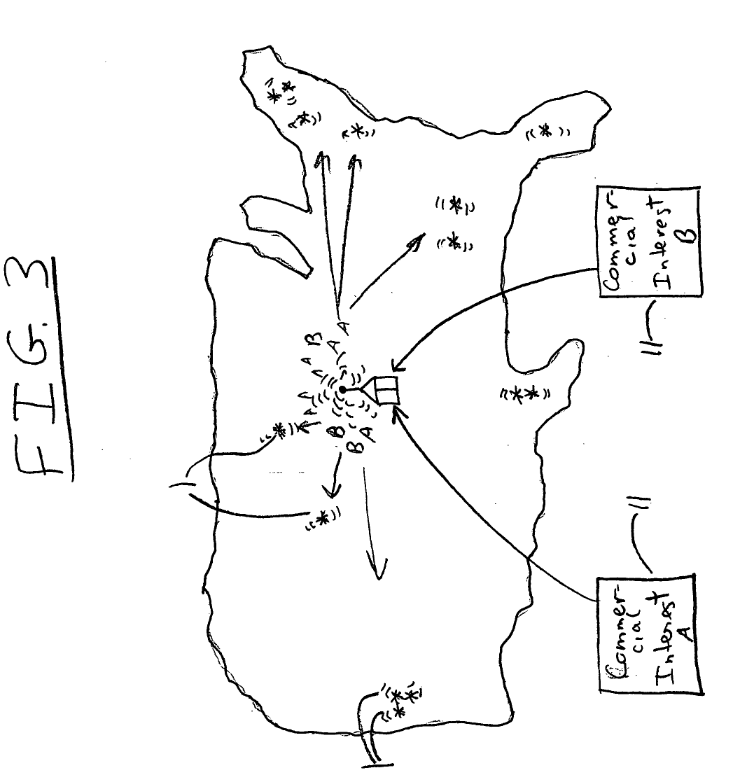

FIG. 3 depicts a sample dispersal of sets of systems 1 in parking structures 9 in various cities across the country and that they can be remotely programmed from a central programming output center 10 based upon the needs and desires of various commercial entities 11. This illustrates the ease with which national retailers and commercial interests will be able to adapt their advertising campaigns to different situations and conditions in different communities. A commercial entity need only contract with the operator of the systems to send by appropriate signal technology the information to be dispensed in the proper parking structure locations. It may even be possible for a commercial entity to obtain an individual identification code so that entity may make changes to its own advertising messages.

### SUMMARY OF THE INVENTION

The current invention avoids these above-discussed limitations. First, it provides a means for business owners to turn a revenue-draining site into a revenue generating site, while at the same time enabling the business to offer a beneficial service and enticement to business patrons. All entities operating garages, such as businesses, colleges and universities, and even municipalities would benefit from this added revenue.

Further, since the device is to be mounted on walls in a garage, the box may be of any size which does not impact driver or pedestrian safety. With this size flexibility, the size and design of maps and associated coupons is not effectively restricted. Indeed, the maps may contain not only coupons, but simply advertisements for different stores in a mall or in an area adjacent to the parking facility, opening up a whole new arena for revenue-production for any facility, grocery store or otherwise.

The invention described herein resolves the deficiencies of the prior part. First, it provides a flexible and efficient means for business owners to turn a revenue-draining site into a revenue generating site, while at the same time enabling the business to offer a beneficial service and enticement to business patrons. All entities operating garages, such as businesses, colleges and universities, and even municipalities would benefit from this added revenue. Second, the remote programmability of the system enables businesses to reach out to a wide range of customers easily and flexibly. Third, the current invention does not rely on a vehicle-mounted device which may only be useful if the parker is already in the vicinity of the vehicle. The current invention provides an effective method for locating the vehicle from wherever in the destination-area the vehicle seeker is at the time they decide to return to the vehicle.

Fourth, the invention described herein does not require the vehicle seeker to carry with them any additional mechanical or electronic device to record the location of the parked vehicle. The current invention provides to the parker either a message direct to their cell-phone or other electronic device or a conveniently-sized paper which the vehicle parker may simply fold up and put into a pants or shirt pocket, a purse or wallet, until the time the vehicle parker desires to return to their car. With the current invention, both the electronic message and the piece of paper may describe both the location of the vehicle (according to whichever color, character, alphanumeric or other identification system the parking lot or garage uses), a simple map illustrating how to best reach that spot from one or a number of parking-utilizing destinations, and contain an advertisement. For example, if the destination is a shopping mall or stadium, the paper may illustrate how to reach the vehicle from two different exits of the facility. Or, the parker may consult another in-store system to receive easiest directions back to the parking location. In this way, the parked-vehicle seeker can clearly know both the location of the vehicle and the path to get there from any number of locations: There is nothing to record, and nothing to remember!!

### DETAILED DESCRIPTION OF THE INVENTION

A preferred embodiment of the present invention may include a container of a shape such as a cube or cylinder or other appropriate design, which may contain inside a roll of sheets such as a well-known type. These sheets may either self-protrude such as on a “take-a-number” device, where the users tear off sequential pieces and such action of tearing brings the next sequential piece into line, or may be caused to protrude automatically by a user pressing a button or passing their hand in front of a sensor of an appropriate type. The device is also able to send the information via an electronic beam to a cell phone or other commonly-carried electronic device. Another preferred embodiment may have a person wave a smart-card in front of a device and the device print a coupon which the database determines would be appropriate for the consumer. The device may be mounted on any pre-existing wall or pillar in the parking structure or may be mounted on a pole or other supporting structure put in place specifically to hold the device.

The present invention may be produced in various versions to accommodate the type of parking structure in which it will be used. For example, if the structure is enclosed or otherwise protected from inclement weather, the paper may come to protrude from the front or top of the device. If the structure is open, then the device may be constructed so the paper comes to protrude from the bottom of the device, or so that the paper protrudes from the front but is protected from inclement weather.

In a preferred embodiment, the device may be a simple housing or container which contains the scroll or papers which have been pre-printed with the parking space locator and map appropriate for that location in the parking structure. In this embodiment, it may be that the installer of the device may have measured and diagrammed the parking structure and surrounding areas in order to design the appropriate maps for each location where the device or system of devices will be installed. In another preferred embodiment, the devices may be equipped with communications or measuring or other spatial-relationship-determining devices such as lasers, transponders, radio frequency identification tags, and the like so to permit the devices both to design and print their own maps and access directions based on the device-to-device communications, and to print coupons or advertisements based on data entered through a networked connection. Devices of this embodiment would contain small printers as are commonly available commercially.

As for the coupon and inducement printing capability, the paper may be pre-printed with a certain coupon or inducement for a period of time, or may contain blank paper scrolls which an internal printer may print as needed, perhaps to accommodate a programmed series of different inducements for different businesses. With a remote programming capability, businesses may reach out to certain audiences with particular demographics. For instance, Cadillac may hire the systems to distribute advertisements for a new model vehicle only in garages across the country located in areas with average household incomes above a certain level, while Toyota may seek advertisements in garages located in areas only with average household incomes below that same level. Similarly, a business which sells sports gear may hire the system to be programmed to dispense advertisements in garages adjacent to where those events are being conducted. Further, by placing date- and/or time-stamps on the paper or within the electronic information, shopping sites can offer special benefits to frequent customers who can demonstrate, for example, that they have shopped at the location—or other locations owned by the same company—five times in the preceding month.

As another example, sports drink and health food manufacturers may hire the systems to distribute advertisements through the systems located around or in the parking garages which service health clubs and gyms. As yet another example, snack food and soda manufacturers may hire the systems to distribute advertisement blitzes during times when many people are planning parties, such as the weeks leading to New Year's and the Super Bowl.

The system is economical enough to offer small or niche businesses a chance to advertise their services without incurring national advertising rates, much in the same way local businesses can advertise through local media outlets. A niche company may be able to hire the systems to distribute advertisements through systems located near target communities across a state or even the nation. For example, sellers of certain types of food products—Chinese, Vietnamese, Indian—can hire the system to distribute coupons in garages or lots which serve those communities. Drawing on other examples above, a local health club may hire the system in an adjacent garage to offer coupons for discount memberships during a membership drive.

In all these ways, remote and flexible programmability permits national outreach and local adaptability. One example, in addition to those noted above, permits national operators of many garages to combine and market their sites in demographic groups and so reap larger fees from advertisers. Locally, the system enables operators of one or smaller garages to compete with one another in a way that was not possible before. For example, garage operators who use the system can now offer, independently or in collaboration with other businesses, coupon, discount or other incentives for shoppers to park in their facility. All these can help draw shoppers to the centers rather than internet shoppers. This system, then, can also benefit the local tax base by increasing shopping in a jurisdiction.

In addition, use of the current invention may provide a business advantage for the parking-utilizing destination. This may be accomplished as follows: The paper or electronic message described above may include the simple map and space identifiers on one side, and an advertisement or appropriately-designed coupon on the other side. In this way, a parking-utilizing destination may be able to encourage a user of the garage to shop in certain shops, to visit certain stores, or to otherwise make use of other parking-utilizing destinations in order to increase the business of all such destinations. For example, imagine a shopping mall with parking garages located on all sides. Next, imagine that a customer of the mall parks on the north parking lot because that entrance is closest to the store they wish to shop in. It might be that a store located on the south side of the mall is having a sale to clear out some seasonal merchandise. In this situation, and others like it, it may be advantageous for the mall to provide information about the sale and perhaps a coupon on the reverse side of the parking space map, and so encourage the mall patron who parks on the north side to visit the shops on the south side of the mall. At the same time, a store located on the north side of the mall may benefit by advertising distributed to patrons who park on the south side of the mall. In these ways, the mall can encourage broader use of the mall by all patrons and generate more revenue for its businesses.

Thus the invention described herein recognizes that it is easiest and even potentially advantageous for business if the owner/operator of the parking garage, lot or shops along a street provide the vehicle locating mechanism. In this way, the owner/operators may also adjust the device or system of devices for new parking technologies or methods. The invention described herein permits that flexibility, while also keeping costs down and providing a business method and revenue stream for the owner or manager of the parking garage, lot or parking-utilizing destination.

In this day of increased internet shopping, it is imperative for so-called traditional or “bricks-and-mortar” retailers to resolve issues that keep shoppers out of their stores and do all they can to make the in-person shopping experience as beneficial, att5ractive and convenient as possible. The current invention helps retailers resolve these issues, not only through the examples described above, but also by removing the burden of shoppers finding their cars after shopping, wandering around the garage with an armful of heavy packages. With this invention, a shopper arrives at the retail location comfortable knowing they will not be lost afterwards.

### SUMMARY DESCRIPTION OF A PREFERRED EMBODIMENT

The invention in a preferred embodiment provides a method of reminding a driver of a parked vehicle of where the vehicle was parked, comprising: in a vicinity where a driver has parked a vehicle (such as within a range of about 50 feet or less of where a driver has parked a vehicle), disposing a container from which is dispensed a physical item or electronic beam of data on which is stated or transmitted a location in which the vehicle has been parked, such as invention methods wherein the electronic beam of data utilizes infra-red or other applicable signal technology to transfer the parking location and other information directly to a vehicle parker's cell phone, PDA, or other similar device; invention methods wherein the physical item being dispensed is paper (such as methods wherein the physical item is caused to be dispensed by manually pressing a button or waving past a light, motion or other sensor; methods wherein a keypad receives input by a vehicle parker inputting a specific parking space designation, and the input is printed onto the dispensed paper which the vehicle parker receives to carry with him or her; methods wherein the dispensed paper includes both the location of the parked vehicle and a map and/or instructions indicating how to return to the parked vehicle). In a preferred embodiment, the emitted electronic transmission of information includes both the location of the parked vehicle and a map and/or instructions indicating how to return to the parked vehicle (and may include other more detailed information such as a guide to shops or commercial locations in the shopping destination, an electronic map, all on-going specials and other and other useful information), wherein the electronic beam is either continually emitted or is activated by manually pressing a button or waving past a light, motion or other sensor, and further wherein a keypad receives input by a vehicle parker inputting a specific parking space designation, and the input is encoded into the transmitting beam of information which the vehicle parker receives in his or her cell phone, PDA or other device.

In a preferred embodiment there shall be included the step in which the system is equipped to be programmed to provide advertisements, site-specific directions and other information on the paper and the electronic beam, and as well including the step in which the system is equipped to be programmed to provide advertising and other information from a physically local site or from a physically separate terminal up to thousands of miles distant, and further wherein multiple systems are able to be programmed simultaneously or individually one-at-a-time.

In a preferred embodiment, the parked vehicle is parked in a parking garage or in an open-air parking lot, wherein multiple systems located within the same parking lot or garage area are capable of electronically locating each other in order to determine the three-dimensional layout of a parking area and the position of each locator device relative to others around it and to automatically print and/or transmit both the location of the car and a map and instructions indicating how to get from any point in the parking garage or lot to the area where a user's vehicle is located. In a preferred embodiment, a system component is installed in a retail or other commercial outlet and the vehicle parker is able to enter their parking location data manually on an external keypad or electronically and to receive back information on the shortest route to return to the original parking location from the current location.

While the invention has been shown and described with respect to a particular embodiment thereof, this is for the purpose of illustration rather than limitation; other variations and modifications of the specific embodiment herein shown and described will be apparent to those skilled in the art all within the intended spirit and scope of the invention. Accordingly, the patent is not to be limited in scope and effect to the specific embodiment shown and described nor in any other way that is inconsistent with the extent to which the progress in the art has been advanced by the invention.

1. A method of reminding a driver of a parked vehicle of where the vehicle was parked, comprising: in a vicinity where a driver has parked a vehicle, disposing a container from which is dispensed a physical item or electronic beam of data on which is stated or transmitted a location in which the vehicle has been parked.

2. The method of claim 1, wherein the electronic beam of data utilizes infra-red or other applicable signal technology to transfer the parking location and other information directly to a page on the vehicle parker's cell phone, PDA, or other similar device.

3. The method of claim 1, wherein the physical item being dispensed is paper.

4. The method of claim 2, wherein the physical item is caused to be dispensed by manually pressing a button or waving past a light, motion or other sensor.

5. The method of claim 3, wherein the electronic beam is either continually emitted or is activated by manually pressing a button or waving past a light, motion or other sensor.

6. The method of claim 2, wherein a keypad receives input by a vehicle parker inputting a specific parking space designation, and the input is printed onto the dispensed paper which the vehicle parker receives to carry with him or her.

7. The method of claim 3, wherein a keypad receives input by a vehicle parker inputting a specific parking space designation, and the input is encoded into the transmitting beam of information which the vehicle parker receives in his or her cell phone, PDA or other device.

8. The method of claim 2, wherein the dispensed paper includes both the location of the parked vehicle and a map and/or instructions indicating how to return to the parked vehicle.

9. The method of claim 3, wherein the emitted electronic beam of information includes both the location of the parked vehicle and a map and/or instructions indicating how to return to the parked vehicle.

10. The method of claim 1, including the step in which the system is equipped to be programmed to provide advertisements, in-store directions and other information on the paper and the electronic beam.

11. The method of claim 1, including the step in which the programming may be performed from a physically local site or from a physically separate terminal up to thousands of miles distant.

12. The method of claim 1, wherein multiple systems are able to be programmed simultaneously or individually one-at-a-time.

13. The method of claim 1, wherein the parked vehicle is parked in a parking garage or in an open-air parking lot.

14. The method of claim 1, wherein multiple systems located within the same parking lot or garage area are capable of electronically locating each other in order to determine the three-dimensional layout of a parking area and the position of each locator device relative to others around it and to automatically print and/or transmit both the location of the car and a map and instructions indicating how to get from any point in the parking garage or lot to the area where a user's vehicle is located.

15. The method of claim 1, wherein a system component is installed in a retail or other commercial outlet and the vehicle parker is able to enter their parking location data manually on an external keypad or electronically and to receive back information on the shortest route to return to the original parking location from the current location.
